(19) United States
(12) Patent Application Publication
(10) Pub. No.: US 2006/0215537 A1
(43) Pub. Date: Sep. 28, 2006

(54) APPARATUS AND METHOD FOR ESTIMATING A CLIPPING PARAMETER OF AN OFDM SYSTEM

(76) Inventors: Wen-Rong Wu, Hsin-Chu City (TW); Chuntao Lin, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/306,804

(22) Filed: Jan. 11, 2006

(30) Foreign Application Priority Data
Feb. 24, 2005 (TW) 094105617

(51) Int. Cl. H04J 11/00

(52) U.S. Cl. 370/208

(57) ABSTRACT

An apparatus and a method for estimating a clipping parameter of an OFDM system are disclosed. The apparatus includes a clipping error detection module for evaluating a received clipping error; a division module coupled to the clipping error detection module for obtaining a characteristic value according to the received clipping error; and a computation module coupled to the division module for estimating the clipping parameter according to the characteristic value.

### BACKGROUND

The present invention relates to an apparatus and a method utilized in a receiver for estimating a clipping parameter corresponding to an OFDM signal, wherein the clipping parameter is utilized by an OFDM transmitter while transmitting the OFDM signal, and more specifically, to an apparatus and a related method utilized in an orthogonal frequency division multiplexing (OFDM) receiver for estimating a clipping parameter corresponding to the OFDM signal.

In an OFDM system according to a related art, a transmitter transmits an OFDM time domain signal processed by an inverse fast Fourier transform (IFFT). Therefore, a peak value relative to a peak-to-average power ratio (PAPR) is usually too high. Hence, it is necessary to reduce the peak value of the OFDM time domain signal. In general, clipping is an easy and efficient method. However, such an operation often causes a so-called clipping error in an OFDM signal which is received by an OFDM receiver. In general, in an OFDM receiver, it is necessary to compensate for a signal distortion resulting from the clipping error through a decision-aided reconstruction (DAR) algorithm or other algorithms.

Please refer to FIG. 1. FIG. 1 is a block diagram of a transmitter 100 according to a related art. The transmitter 100 comprises a signal mapper 102, an inverse Fourier transform (IFT) module 104, a clipping module 106, a digital-to-analog converter (DAC) 108, a power amplifier (PA) 110, and a transmitting antenna 112. The signal mapper 102 maps a digital data Dᵢₙ to a signal space to generate a mapping signal {Xₖ} according to a specific modulation mechanism (i.e., a digital television broadcasting system DVB-T can select one from the following three modulation mechanisms, QPSK, 16QAM and 64QAM). The IFT module 104 is utilized for converting the mapping signal {Xₖ} (an OFDM frequency domain signal) to an OFDM time domain signal {Xₙ}. The clipping module 106 performs a typical clipping procedure on the OFDM time domain signal {xₙ} according to a clipping threshold to generate a clipping OFDM time domain signal {yₙ}. Next, the clipping OFDM time domain signal {yₙ} is converted by the DAC 108 and then amplified by the power amplifier 110. Finally, the transmitting antenna 112 transmits the clipping OFDM time domain signal.

The OFDM time domain signal xₙ output by the IFT module 104 corresponding to the n^{th} time frame is described by the following equation:

$${x}_{n} = \frac{1}{\sqrt{N}} {\sum }_{k = 0}^{N - 1} {X}_{k} exp \{ j \frac{2 π nk}{N} \} , 0 \leq n \leq N - 1 \qquad Equation ( 1 )$$

In equation (1), Xₖ is a sub-carrier signal corresponding to a k^{th} sub-carrier, where N denotes the number of sub-carriers.

As mentioned above, the clipping module 106 performs a clipping procedure according to a clipping threshold. The operation of the clipping procedure is described by the following equation:

$${y}_{n} = \{ \begin{matrix}{x}_{n} , & \vert {x}_{n} \vert \leq A , \\ A \cdot {ⅇ}^{arg ( {x}_{n} )} , & \vert {x}_{n} \vert > A ,\end{matrix} \qquad Equation ( 2 )$$

In equation (2), wherein A denotes the clipping threshold, xₙ denotes the OFDM time domain signal corresponding to an n^{th} time frame, arg(xₙ) denotes the phase of xₙ, and yₙ denotes the clipping OFDM time domain signal corresponding to the OFDM time domain signal xₙ. Usually, a clipping ratio is utilized for representing the degree of the time domain signal {xₙ} affected by clipping, and the clipping ratio is denoted as

$$χ = \frac{A}{σ}$$

wherein σ=(var(xₙ))^{1/2} is the root mean square value of the signal {xₙ}.

From equation (2), the clipping operation can be described: If at a sampling time point, the magnitude of an input signal is greater than the clipping threshold A, the clipping threshold A is utilized as the magnitude of the clipping signal and the phase of the input signal is kept as the phase of clipping signal. On the other hand, if at that sampling time point, the magnitude of the input signal is not greater than the clipping threshold A, both the magnitude and phase of the input signal kept as the clipping signal. In other words, the clipping threshold A is utilized for limiting the maximum magnitude of an input signal tolerated by the power amplifier 110 of the transmitter 100.

FIG. 2 is a diagram of an OFDM receiver 200 according to the related art. Please refer to the paper “Clipping noise mitigation for OFDM by decision-aided reconstruction,” IEEE Commun. Lett., vol. 3, pp. 4-6, January 1999, published by D. Kim, G. L. Stuber. The detailed description of the circuits and operations thereof are included in the following. The receiver 200 utilizes a decision-aided reconstruction mechanism and comprises an antenna 202, a cyclic prefix removal and Fast Fourier transform module 204 (CP removal/FFT module 204), a channel estimation module 205, a frequency equalization (FEQ) module 206, a plurality of IFT modules 208 and 210, a decision module 212, a Fourier transform module 214 and a reconstruction module 216. The antenna 202 is utilized for receiving an OFDM time domain signal, such as a clipping OFDM time domain signal finally output by the transmitter 100 shown in FIG. 1. The CP removal/FFT module 204 removes a cyclic prefix (CP) component of the OFDM time domain signal received by the antenna 202. An OFDM frequency domain signal {Zₖ} is generated by the fast Fourier transform operation. The channel estimation module 205 estimates a channel response {Hₖ} according to the OFDM frequency domain signal {Zₖ}. The frequency equalization module 206 further generates an equalized frequency domain signal {Z′ₖ} according to the estimated channel response {Hₖ} and the OFDM frequency domain signal {Zₖ}. Next, the IFT module 208 performs an inverse Fourier transform on the equalized frequency domain signal {Z′ₖ} to generate an equalized time domain signal {z′ₙ}. As shown in FIG. 2, when the frequency equalization module 206 generates the equalized frequency domain signal {Z′ₖ}, the decision module 212 receives the OFDM frequency domain signal {Zₖ} and the channel response {Hₖ} generated by the channel estimation module 205 to generate a frequency domain decision signal {X′ₖ} by performing a hard decision. The frequency domain decision signal {X′ₖ} is described by the following equation,

$${X}_{k}^{′} = {min}_{\{ X \}} \vert {Z}_{k} - {H}_{k} X \vert , 0 \leq k \leq N - 1$$

The IFT module 210 next performs an inverse fast Fourier transform (IFFT) on the frequency domain decision signal {X′ₖ} to generate a time domain decision signal {x′ₙ}. Meanwhile, the reconstruction module 216 initializes a reconstruction procedure according to the time domain decision signal {x′ₙ} and the equalized time domain signal {z′ₙ}. The reconstruction procedure performed by the reconstruction module 216 is described by the following equation:

$${r}_{n} = \{ \begin{matrix}{x}_{n}^{′} , & \vert {x}_{n}^{′} \vert > {A}^{′} \\ {z}_{n}^{′} , & \vert {x}_{n}^{′} \vert \leq {A}^{′}\end{matrix} 0 \leq n \leq N - 1 \qquad Equation ( 3 )$$

In equation (3), A′ is a predetermined value and n is the index of the time frames. A′ can only be formed by prediction because the receiver 200 does not know the clipping threshold utilized by the transmitter.

From equation (3), we know that the reconstruction operation procedure is: for a time frame n, if the absolute value of the time domain decision signal x′ₙ is greater than a predetermined value A′, a reconstructed time domain signal {rₙ} is generated by the time domain decision signal x′ₙ. On the other hand, if the absolute value of the time domain decision signal x′ₙ is not greater than the predetermined value A′, the original equalized time domain signal z′ₙ is utilized as the above-mentioned reconstructed time domain signal rₙ. Finally, the Fourier transform module 214 generates a reconstructed frequency domain signal {Rₖ} by performing a Fourier transform on the reconstructed time domain signal {rₙ}. The decision module 212 performs a hard decision according to the reconstructed frequency domain signal {Rₖ}, instead of according to the frequency domain signal {Zₖ}, to obtain a more accurate frequency domain decision signal {X′ₖ}. When the above-mentioned steps are repeatedly performed, the receiver 200 can suppress the clipping error of the frequency domain decision signal {X′ₖ}, which is caused by the clipping procedure performed by the transmitter.

As mentioned above, it is necessary to use the clipping threshold A of the transmitter when the decision-aided reconstruction algorithm is performed. However, for the OFDM receiver according to the related art, the clipping threshold A of the transmitter cannot be obtained. Therefore, the OFDM receiver utilizes a predetermined value A′ as the clipping threshold of the transmitter. Obviously, the predetermined value is only formed by prediction that cannot fully satisfy the requirement, resulting in a poor performance of the decision-aided reconstruction mechanism according to the related art.

### SUMMARY

One of the objectives of the claimed invention is therefore to provide an apparatus and a method utilized in an orthogonal frequency division multiplexing (OFDM) receiver for estimating a clipping parameter (a clipping threshold or a clipping ratio) corresponding to an OFDM signal, wherein the clipping parameter is utilized by an OFDM transmitter while transmitting the OFDM signal, to solve the above problem.

According to the claimed invention, an apparatus utilized in an OFDM receiver for estimating a clipping parameter corresponding to an OFDM time domain signal is disclosed. The apparatus comprises: a clipping error detection module, a division module and a computation module. The clipping error detection module is utilized for evaluating a clipping error corresponding to the sub-carrier according to a difference between a sub-carrier signal corresponding to the sub-carrier and a frequency domain decision signal. The division module is utilized for obtaining a characteristic value corresponding to the sub-carrier by dividing a power value of the clipping error corresponding to the sub-carrier and by power value of the frequency domain decision signal. The computation module is utilized for estimating a clipping parameter according to an average characteristic value, wherein the average characteristic value is an average of at least one characteristic value respectively corresponding to one sub-carrier.

Furthermore, according to the claimed invention, a method utilized in an OFDM receiver for estimating a clipping parameter corresponding to an OFDM signal, wherein the clipping parameter is utilized by an OFDM transmitter while transmitting the OFDM signal is disclosed. The method comprises: detecting a clipping error corresponding to a sub-carrier according to a difference between a sub-carrier signal corresponding to the sub-carrier and a frequency domain decision signal; obtaining a characteristic value corresponding to the sub-carrier by dividing a power value of the clipping error corresponding to the sub-carrier by a power value of the frequency domain decision signal; and obtaining a clipping parameter according to an average characteristic value, wherein the average characteristic value is an average of at least one characteristic value each characteristic value corresponding to one sub-carrier.

The apparatus and the method utilized in a receiver for estimating a clipping parameter of a transmitter comprise, obtaining the ratio of the power value of the clipping error to the power value of the sub-carrier signal, and then estimating the desired clipping parameter by performing an operation according to a specific functional relationship. The apparatus and the method for estimating the clipping parameter according to the claimed invention further include establishing a mapping table according to the specific functional relationship, and generating the desired clipping parameter efficiently by looking up the mapping table after obtaining the ratio of the power value of the clipping error to the power value of the sub-carrier signal. The apparatus and the method for estimating the clipping parameter according to the claimed invention can dynamically estimate the clipping parameter adopted by the transmitter. Therefore, the receiver can apply the suitable clipping parameter provided by the claimed apparatus and method to perform other related mechanisms (i.e., the decision-aided reconstruction mechanism) to achieve the goal of suppressing clipping error.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a transmitter according to a related art.

FIG. 2 is a diagram of an OFDM receiver according to the related art.

FIG. 3 is a block diagram of a clipping parameter estimation apparatus utilized in an OFDM receiver according to the present invention.

FIG. 4 is a block diagram of an embodiment of the clipping parameter estimation apparatus shown in FIG. 3.

### DETAILED DESCRIPTION

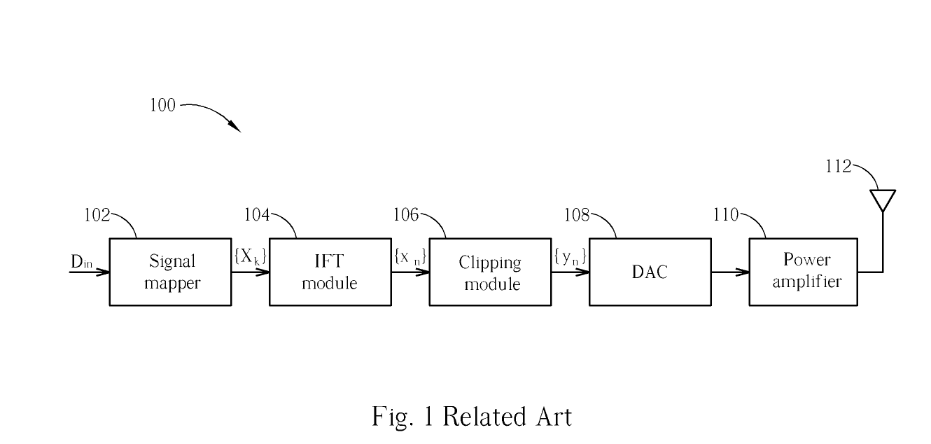

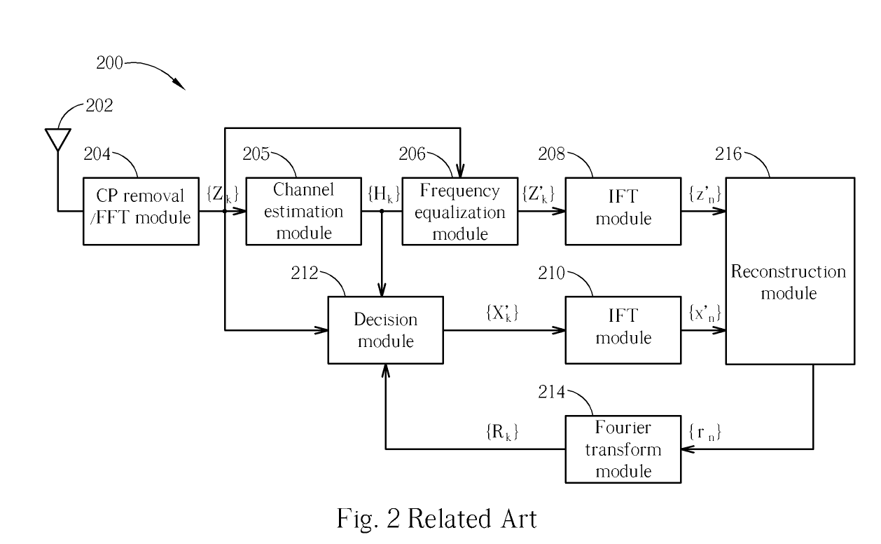

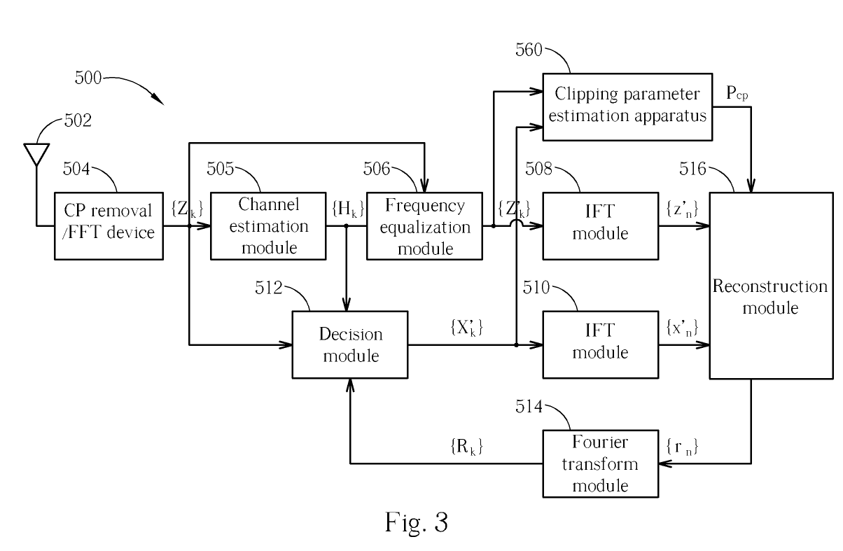

Please refer to FIG. 3. FIG. 3 is a block diagram of a clipping parameter estimation apparatus 560 utilized in an OFDM receiver 500 according to the present invention. In addition to the clipping parameter estimation apparatus 560, the orthogonal frequency division multiplexing (OFDM) receiver 500 further comprises a antenna 502, a cyclic prefix (CP) removal/FFT device 504, a channel estimation module 505, a frequency equalization module 506, a plurality of IFT modules 508 and 510, a decision module 512, a Fourier transform module 514 and a reconstruction module 516. The antenna 502 is utilized for receiving an OFDM time domain signal, such as the clipping OFDM time domain signal output by the transmitter 100 shown in FIG. 1. The CP removal/FFT device 504 removes the cyclic prefix components in an OFDM symbol of the OFDM time domain signal, and then performs a fast Fourier transform operation to generate an OFDM frequency domain signal {Zₖ}. The OFDM frequency domain signal {Zₖ} consists of a plurality of sub-carrier signals Zₖ, wherein k=0, 1, 2, . . . , N−1. The channel estimation module 505 estimates a channel response {Hₖ} according to the OFDM frequency domain signal {Zₖ}. Next, the frequency equalization module 506 outputs an equalized frequency domain signal {Z′ₖ} according to the estimated channel response {Hₖ} and an OFDM frequency domain signal {Zₖ}. The decision module 512 generates a frequency domain decision signal {X′ₖ} according to the channel response {Hₖ} and the OFDM frequency domain signal {Zₖ}. The clipping parameter estimation apparatus 560 calculates a clipping parameter P_{cp} according to the OFDM frequency domain signal {Zₖ}. Finally, the reconstruction module 516 generates a reconstructed time domain signal {rₙ} according to a time domain decision signal {x′ₙ}, an equalized time domain signal {z′ₙ}, and the clipping parameter P_{cp}, wherein the time domain decision signal {x′ₙ} is generated by the IFT module 510 receiving the frequency domain decision signal {X′ₖ}, and the equalized time domain signal {z′ₙ} is generated by the IFT module 508 receiving the equalized frequency domain signal {Z′ₖ}. According to the operation of the decision-aided reconstruction mechanism of the related art OFDM receiver 200 shown in FIG. 2, the decision module 512 shown in FIG. 3 further determines the frequency domain decision signal {X′ₖ} according to the channel response {Hₖ} and a reconstructed frequency domain signal {Rₖ} generated by the Fourier transform module 514 which receives the reconstructed time domain signal {rₙ}, in order to suppress the the clipping error of the frequency domain decision signal {X′ₖ}, which is caused by the clipping procedure performed by the transmitter. It should be noted that in the OFDM receiver 500, except for the clipping parameter estimation apparatus 560, all other components are well known in the art. Hence, the description of the related circuit structures and operation theories are not included in the following paragraph.

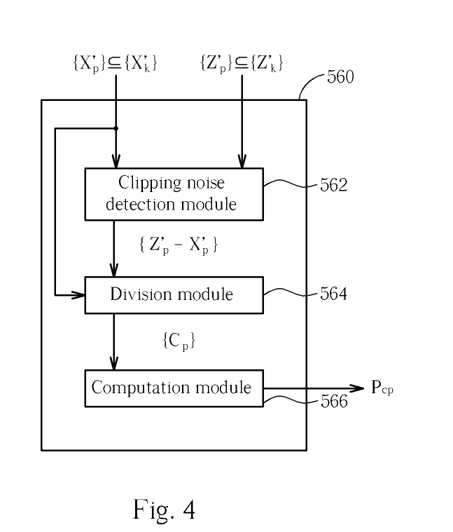

In the OFDM receiver 500, the clipping parameter estimation apparatus 560 according to the present invention can estimate the clipping parameter P_{cp}, corresponding to an OFDM signal such as the clipping threshold or the clipping ratio, which is utilized by the OFDM transmitter for transmitting the OFDM signal. Compared with the related art, in which the reconstruction module 212 shown in FIG. 2 utilizes a fixed value to be the clipping threshold, the operation of the clipping parameter estimation apparatus 560 facilitates the reconstruction module 516 according to the present invention to have better performance. Please refer to FIG. 4. FIG. 4 is a block diagram of an embodiment of the clipping parameter estimation apparatus 560. The clipping parameter estimation apparatus 560 comprises a clipping error detection module 562, a division module 564 and a computation module 566. In the present embodiment, the clipping error detection module 562 is utilized for processing the sub-carrier signal {Z′ₚ, pεI} corresponding to a plurality of transmitted known data, wherein 1 is a set of indexing numbers of the sub-carrier signals respectively carrying the known data. That is, 1 is a subset of {0, 1, 2, . . . , N−1}, and {Z′ₚ, pεI} is a subset of {Z′ₖ, k=0, 1, 2, . . . , N−1}. In the preferred embodiment, the clipping parameter estimation apparatus 560 is applied in an OFDM communication system. Therefore the above-mentioned sub-carrier signal {Z′ₚ} is a pilot signal in the OFDM communication system, such as a Scattered Pilot, a Continual Pilot or a TPS pilot. The sub-carrier signal {Z′ₚ} is utilized for transmitting a known data, and therefore the clipping parameter estimation apparatus 560 can evaluate the clipping error {Z′ₚ−Xₚ} according to a difference between the sub-carrier signal {Z′ₚ} and the corresponding frequency domain decision signal {Xₚ}, which is a known data. Next, the division module 564 generates a characteristic value {Cₚ} by performing a fractional operation on a power value {E(|Z′ₚ−Xₚ|²)} of the clipping error {Z′ₚ−Xₚ} and a power value {E(|Xₚ|²)} corresponding to the frequency domain decision signal {Xₚ}. Finally, the computation module 566 generates an average characteristic value V by averaging a plurality of characteristic values {Cₚ}. It should be noted that the average characteristic value V is an average of at least one characteristic value. Next, the desired clipping parameter P_{cp} is obtained according to the average characteristic value V.

The description of the operational theory of the clipping parameter estimation apparatus 560 is as follows, which is derived from the clipping procedure performed by the OFDM transmitter. It should be noted that the channel noise effect will not be taken into consideration. The clipping procedure could be represented as its time domain characteristic which is described previously as equation (2), the frequency domain characteristic could also be modeled for the k^{th} sub-carrier here as equation (4):
Yₖα·Xₖ+Dₖ, k=0, 1, 2, . . . , N−1 Equation (4)
In equation (4), α is an attenuation factor related to the sub-carrier signal attenuation during clipping procedure, D_{K} is the clipping noise representing the clipping effect occurred on the k^{th} sub-carrier signal other than the attenuation. The relationship between the attenuation factor α and the clipping ratio γ which is known by the one of those skilled in the art, is shown in the following equation:

$$α = 1 - {ⅇ}^{- {γ}^{2}} + \frac{\sqrt{π} γ}{2} erfc ( γ )$$

Wherein, erfc(•) is a complementary error function. From equation (4), the power value P_{Y}_{ₖ} of the sub-carrier signal Yₖ can be represented by the following equation (5):
P_{Y}_{ₖ}α²·P_{X}_{ₖ}P_{D}_{ₖ}, k=0, 1, 2, . . . , N−1 Equation (5)

After being transmitted through the transmission channel and being received and processed by the OFDM receiver 500 through the antenna 502 and the CP removal/FFT device 504, the received OFDM frequency domain signal {Zₖ} consists of a plurality of sub-carrier signals Zₖ. The sub-carrier signal Zₖ is:
Zₖ=Hₖ·Yₖ=Hₖ(α·Xₖ+Dₖ), k=0, 1, 2, . . . , N−1 Equation (6)

After equalizing the sub-carrier signal Zₖ,

$${Z}_{k}^{′} = \frac{{Z}_{k}}{α - {H}_{k}} = {X}_{k} + \frac{{D}_{k}}{α} , k = 0 , 1 , 2 , … , N - 1 \qquad Equation ( 7 )$$

In equation (7), {Hₖ} denotes a channel response corresponding to all sub-carrier signals. In addition, the power value P_{Z′}_{ₖ} of the sub-carrier signal Z′ₖ can be obtained by equation (7):

$${P}_{{Z}_{k}^{′}} = E ( {\vert {Z}_{k}^{′} \vert}^{2} ) = {P}_{{X}_{k}} + \frac{{P}_{{D}_{k}}}{{α}^{2}} \qquad Equation ( 8 )$$

In equation (8), P_{X}_{ₖ}=E(|Xₖ|²) represents the power value of the frequency domain decision signal Xₖ, and P_{D}_{ₖ}=E(|Dₖ|²) represents the power value of the clipping noise value Dₖ that affects the k^{th} sub-carrier.

Additionally, as known by the one of those skilled in the art, the relationship between the power value P_{X}_{ₖ} of the sub-carrier signal before the clipping procedure and the power value P_{Y}_{ₖ}=E(|Yₖ|²) after the clipping procedure can be represented by the following equation:
P_{Y}_{ₖ}=(1−e^{-γ}^{²})P_{X}_{ₖ}, k=0, 1, 2, . . . , N−1 Equation (9)

By using equations (5) and (9), the ratio of the power value of the received clipping error {Z′ₖ−Xₖ} to the power value of the frequency domain decision signal {Xₖ} (the ratio also can be represented as a characteristic value Cₖ) is:

$${C}_{k} = \frac{E ( {\vert {Z}_{k}^{′} - {X}_{k} \vert}^{2} )}{E ( {\vert {X}_{k} \vert}^{2} )} = \frac{{P}_{{Z}_{k}^{′}} - {P}_{{X}_{k}}}{{P}_{{X}_{k}}} = \frac{1 - {ⅇ}^{- {γ}^{2}} - {α}^{2}}{{α}^{2}} \qquad Equation ( 10 )$$

The clipping parameter P_{cp} output by the clipping parameter estimation apparatus 560 according to the present invention can be either a clipping ratio or a clipping threshold. The selection of the clipping ratio or the clipping threshold is according to the requirement of the OFDM receiver. For example, the OFDM receiver 500 shown in FIG. 3 applies a decision-aided reconstruction mechanism. The clipping parameter estimation apparatus 560 therefore outputs a clipping threshold as the clipping parameter P_{cp} to the reconstruction module 516. If the clipping ratio γ is required by the OFDM receiver, the functional relationship between the average characteristic value V and the clipping ratio γ which is utilized by the computation module 566 is:

$$V = 1 - {ⅇ}^{- {γ}^{2}} - {( 1 - {ⅇ}^{{γ}^{2}} + \frac{\sqrt{π} γ}{2} erfc ( γ ) )}^{2} \qquad Equation ( 11 )$$

For improving the operational efficiency of the clipping parameter estimation apparatus 560, a mapping table (look-up table) is prepared in the clipping parameter estimation apparatus 560 according to the functional relationship of equation (11). Hence, a clipping ratio γ can be efficiently obtained according to the average characteristic value V and the mapping table.

If the clipping threshold A is required by an OFDM receiver, the functional relationship between the average characteristic value V and the clipping threshold A which is utilized by the computation module 566 is:

$$V = 1 - {ⅇ}^{- {( \frac{A}{{P}_{avg}} )}^{2}} - {( 1 - {ⅇ}^{- {( \frac{A}{{P}_{S}} )}^{2}} + \frac{\sqrt{π} ( \frac{A}{{P}_{avg}} )}{2} erfc ( \frac{A}{{P}_{avg}} ) )}^{2} \qquad Equation ( 12 )$$

Similarly, for improving the operational efficiency of the clipping parameter estimation apparatus 560, a mapping table (look-up table) is prepared in the clipping parameter estimation apparatus 560 according to the functional relationship of equation (12). Hence, a clipping threshold A can be efficiently obtained according to the average characteristic value V and the mapping table.

It should be noted that in the above-mentioned embodiment, the clipping parameter estimation apparatus 560 obtains the clipping parameter by utilizing the pilot signal to achieve better performance. However, the sub-carrier signals {Z′ₚ, PεI} are not limited to the pilot signals, if one sub-carrier signal Z′ₚ within the sub-carrier signals {Z′ₚ} is not a pilot signal for carrying known data, the frequency domain decision signal X′ₚ corresponding to the sub-carrier signal Z′ₚ is determined by a decision process. For example, the decision module 512 performs the decision process on the sub-carrier signal Z′ₚ and obtains the frequency domain decision signal, then supplies to the clipping parameter estimation apparatus 560.

Be compared with the related art, the apparatus and the method utilized in a receiver for estimating a clipping parameter of a transmitter evaluate the ratio of the power value of the clipping error to the power value of the frequency domain decision signal, and then obtain the desired clipping parameter by performing an operation according to a specific functional relationship. Moreover, the apparatus and the method for estimating the clipping parameter according to the claimed invention further include establishing a mapping table according to the specific functional relationship, and obtaining the desired clipping parameter efficiently by looking up the mapping table after evaluating the ratio of the power value of the clipping error to the power value of the frequency domain decision signal. The apparatus and the method for estimating the clipping parameter according to the claimed invention can dynamically estimate the clipping parameter adopted by the transmitter. Therefore, the receiver can apply the suitable clipping parameter provided by the claimed apparatus and method to perform other related operation (i.e., the decision-aided reconstruction operation) to achieve the goal of suppressing the clipping error.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method utilized in an orthogonal frequency division multiplexing (OFDM) receiver for estimating a clipping parameter corresponding to an OFDM time domain signal, wherein the receiver receives the OFDM time domain signal and converts the OFDM time domain signal to an OFDM frequency domain signal consisting of a plurality of sub-carrier signals, the method comprising:
(a) detecting a clipping error corresponding to a sub-carrier according to a difference between a sub-carrier signal corresponding to the sub-carrier and a frequency domain decision signal;
(b) obtaining a characteristic value corresponding to the sub-carrier by dividing a power value of the clipping error corresponding to the sub-carrier by a power value of the frequency domain decision signal; and
(c) obtaining a clipping parameter according to an average characteristic value, wherein the average characteristic value is an average of at least one characteristic value respectively corresponding to one sub-carrier.

2. The method of claim 1, wherein the frequency domain decision signal corresponding to the sub-carrier is a known value.

3. The method of claim 1, wherein the frequency domain decision signal corresponding to the sub-carrier is determined in accordance with the sub-carrier signal.

4. The method of claim 1, wherein the clipping parameter is a clipping ratio, and the clipping ratio is obtained by a predetermined functional relationship between the average characteristic value and the clipping ratio.

5. The method of claim 4, wherein the clipping ratio corresponding to the average characteristic value is obtained by looking up a table.

6. The method of claim 4, wherein in step (c), the functional relationship between the average characteristic value V and the clipping ratio is:
$$V = 1 - {ⅇ}^{- {γ}^{2}} - {( 1 - {ⅇ}^{- {γ}^{2}} + \frac{\sqrt{π} γ}{2} erfc ( γ ) )}^{2}$$
wherein, erfc(•) is a complementary error function

7. The method of claim 1, wherein the clipping parameter is a clipping threshold, and the clipping threshold is obtained by a predetermined functional relationship between the average characteristic value and the clipping threshold.

8. The method of claim 7, wherein the clipping threshold corresponding to the average characteristic value is obtained by looking up a table.

9. The method of claim 7, wherein in step (c), the functional relationship between the average characteristic value V and the clipping threshold A is:
$$V = 1 - {ⅇ}^{- {( \frac{A}{{P}_{avg}} )}^{2}} - {( 1 - {ⅇ}^{- {( \frac{A}{{P}_{S}} )}^{2}} + \frac{\sqrt{π} ( \frac{A}{{P}_{avg}} )}{2} erfc ( \frac{A}{{P}_{avg}} ) )}^{2}$$
wherein erfc(•) is a complementary error function

10. An apparatus utilized in an orthogonal frequency division multiplexing (OFDM) receiver for estimating a clipping parameter corresponding to an OFDM time domain signal, wherein the receiver receives the OFDM time domain signal and converts the OFDM time domain signal to an OFDM frequency domain signal consisting of a plurality of sub-carrier signals, the apparatus comprising:
a clipping error detection module for evaluating a clipping error corresponding to the sub-carrier according to a difference between a sub-carrier signal corresponding to the sub-carrier and a frequency domain decision signal;
a division module coupled to the clipping error detection module for obtaining a characteristic value corresponding to the sub-carrier by dividing a power value of the clipping error corresponding to the sub-carrier by a power value of the frequency domain decision signal; and
a computation module coupled to the division module for estimating a clipping parameter according to an average characteristic value, wherein the average characteristic value is an average of at least one characteristic value respectively corresponding to one sub-carrier.

11. The apparatus of claim 10, wherein the frequency domain decision signal corresponding to the sub-carrier is a known value.

12. The apparatus of claim 10, wherein the frequency domain decision signal corresponding to the sub-carrier is determined in accordance with the sub-carrier signal.

13. The apparatus of claim 10, wherein the clipping parameter is a clipping ratio, and the clipping ratio is obtained by a predetermined functional relationship between the average characteristic value and the clipping ratio.

14. The apparatus of claim 13, wherein the clipping ratio corresponding to the average characteristic value is obtained by looking up a table.

15. The apparatus of claim 13, wherein in step (c), the functional relationship of the average characteristic value V and the clipping ratio is:
$$V = 1 - {ⅇ}^{- {γ}^{2}} - {( 1 - {ⅇ}^{- {γ}^{2}} + \frac{\sqrt{π} γ}{2} erfc ( γ ) )}^{2}$$
wherein, erfc(•) is a complementary error function

16. The apparatus of claim 10, wherein the clipping parameter is a clipping threshold, and the clipping threshold is obtained by a predetermined functional relationship between the average characteristic value and the clipping threshold.

17. The apparatus of claim 16, wherein the clipping threshold corresponding to the average characteristic value is obtained by looking up a table.

18. The apparatus of claim 16, wherein in step (c), the functional relationship of the average characteristic value V and the clipping threshold A is:
$$V = 1 - {ⅇ}^{- {( \frac{A}{{P}_{avg}} )}^{2}} - {( 1 - {ⅇ}^{- {( \frac{A}{{P}_{S}} )}^{2}} + \frac{\sqrt{π} ( \frac{A}{{P}_{avg}} )}{2} erfc ( \frac{A}{{P}_{avg}} ) )}^{2}$$
wherein, erfc(•) is a complementary error function
